(19) United States
(12) Patent Application Publication
(10) Pub. No.: US 2014/0247490 A1
(43) Pub. Date: Sep. 4, 2014

(54) CLEANING MODULE FOR PROJECTOR

(71) Applicant: DELTA ELECTRONICS, INC., Taoyuan Hsien (TW)

(72) Inventor: Hsiu-Ming Chang, Taoyuan Hsien (TW)

(73) Assignee: DELTA ELECTRONICS, INC., Taoyuan Hsien (TW)

(21) Appl. No.: 13/886,051

(22) Filed: May 2, 2013

(30) Foreign Application Priority Data
Mar. 4, 2013 (TW) 102107507

(51) Int. Cl. G02B 27/00; G03B 21/54

(52) U.S. Cl. CPC G02B 27/0006; G03B 21/54
USPC 359/509

(57) ABSTRACT

A cleaning module for cleaning an optical element or a sensing element of a projector is provided. The cleaning module includes a casing, an airflow-guiding device, and a nozzle. The airflow-guiding device is disposed within the casing. The nozzle is connected with the casing and in communication with an outlet of the airflow-guiding device. An opening of the nozzle faces the optical element or the sensing element, so that an airflow guided by the airflow-guiding device is directed to the optical element or the sensing element to remove dust from the optical element or the sensing element. Moreover, when a systematic fan of the projector is disabled, the airflow-guiding device is enabled.

### FIELD OF THE INVENTION

The present invention relates to a cleaning module, and more particularly to a cleaning module for a projector.

### BACKGROUND OF THE INVENTION

In recent years, a variety of projectors have been widely used in various video applications. For example, projectors can be used for making presentations, holding meetings or giving lectures in classrooms, boardrooms, conference rooms or home theaters. By a projector, an image signal from an image signal source can be enlarged and shown on a projection screen. However, during operations of the projector, a great amount of heat is generated. If the heat is not effectively dissipated away, the projector may be over-heated. In the event of the over-heated situation, the projector fails to be normally operated or damaged, or the use life of the projector is reduced. For effectively removing the heat from the projector, the projector is usually equipped with a heat-dissipating module.

Generally, the heat-dissipating module comprises a fan. The fan may inhale a cool airflow into the internal portion of the projector and exhaust a heated airflow to the environment. However, during the cool airflow is inhaled into the projector, external dust is readily introduced into the internal portion of the projector along with the airflow. If the dust is adsorbed on the optical elements within the projector, the performance of the optical elements may be adversely affected. Nowadays, there are two dust-proof mechanisms for avoiding the influence of dust. In accordance with a first dust-proof mechanism, the optical module of the projector is sealed. In accordance with a second dust-proof mechanism, the projector is further equipped with a dust-proof element (e.g. an airflow filter).

FIG. 1 is a schematic view illustrating a projector with a first dust-proof mechanism according to the prior art. As shown in FIG. 1, the projector 10 comprises an optical element 11, an inner casing 12, plural fins 13, and a systematic fan 14. The inner casing 12 is used for sealing the optical element 11 in order to protect the optical element 11 from being contaminated by the external dust. The fins 13 are disposed on the inner casing 12 for increasing the heat transfer area. The heat generated by the optical element 11 is firstly transferred to the inner casing 12, and then the heat is removed from the inner casing 12 by the airflow which is inhaled by the systematic fan 14. Consequently, the temperature of the overall projector is reduced. Although the way of sealing the optical element is effective to protect the optical element 11 from being contaminated by the external dust, the temperature of the working optical element 11 is still high and the use life of the optical element 11 is reduced. For reducing the temperature of the overall projector, it is necessary to increase the rotating speed of the systematic fan 14. Under this circumstance, the noise generated by the systematic fan 14 is increased.

FIG. 2 is a schematic view illustrating a projector with a second dust-proof mechanism according to the prior art. As shown in FIG. 2, the projector 20 is equipped with an airflow filter 21 at an entrance of the projector 20. The airflow filter 21 is used for filtering off the external dust. The use of the airflow filter 21 is effective to prevent the external dust from being introduced into the internal portion of the projector 20. However, since the airflow filter 21 may increase the resistance of the airflow, the heat-dissipating efficacy of the overall projector 20 is reduced. Moreover, the heat-dissipating capability of other components which are not sensitive to dust may be also impaired. For reducing the temperature of the overall projector, it is necessary to increase the rotating speed of the systematic fan (not shown). Under this circumstance, the noise generated by the systematic fan is increased.

Therefore, there is a need of providing an improved cleaning module for a projector in order to eliminate the above drawbacks.

### SUMMARY OF THE INVENTION

The present invention provides a cleaning module for removing dust from an optical element or a sensing element of a projector in order to enhance the performance of the projector and prevent the erroneous action of the projector.

In accordance with an aspect of the present invention, there is provided a cleaning module for cleaning an optical element or a sensing element of a projector. The cleaning module includes a casing, an airflow-guiding device, and a nozzle. The airflow-guiding device is disposed within the casing. The nozzle is connected with the casing and in communication with an outlet of the airflow-guiding device. An opening of the nozzle faces the optical element or the sensing element, so that an airflow guided by the airflow-guiding device is directed to the optical element or the sensing element to remove dust from the optical element or the sensing element. Moreover, only when a systematic fan of the projector is disabled, the airflow-guiding device is enabled.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a projector with a first dust-proof mechanism according to the prior art;

FIG. 2 is a schematic view illustrating a projector with a second dust-proof mechanism according to the prior art;

FIG. 3 is a schematic view illustrating the architecture of a projector according to an embodiment of the present invention;

FIG. 4 is a schematic view illustrating a cleaning module and the optical element and the sensing element to be cleaned by the cleaning module according to an embodiment of the present invention;

FIG. 5 is a schematic view illustrating the cleaning module, the optical element and the sensing element of FIG. 4 and taken along another viewpoint;

FIG. 6 is a schematic view illustrating a cleaning module installed on a door plate of an outer shell of the projector according to the embodiment of the present invention; and

FIGS. 7A˜7G are schematic timing waveform diagrams illustrating the applied voltages of the airflow-guiding device in some possible operating modes of the airflow-guiding device of the cleaning module according to the present invention.

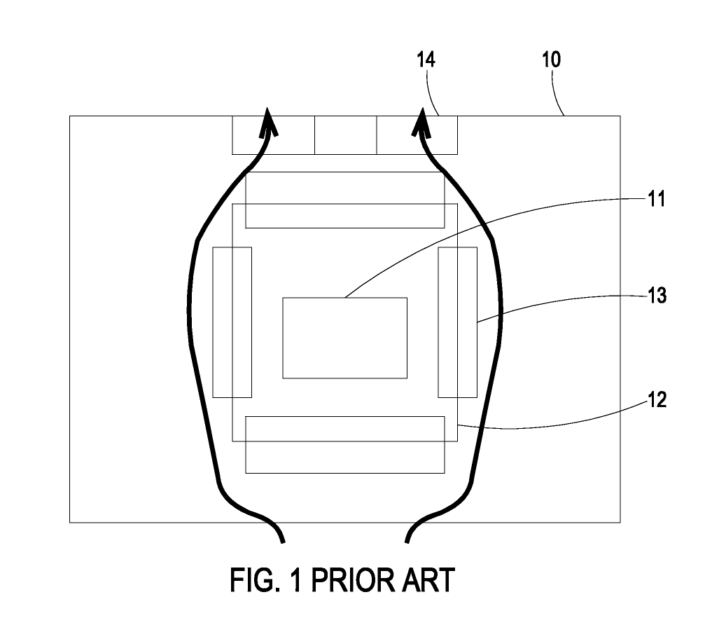

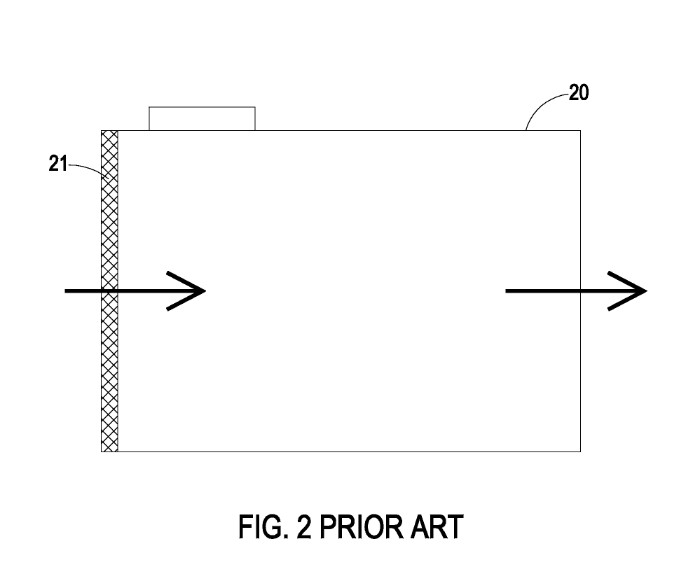

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

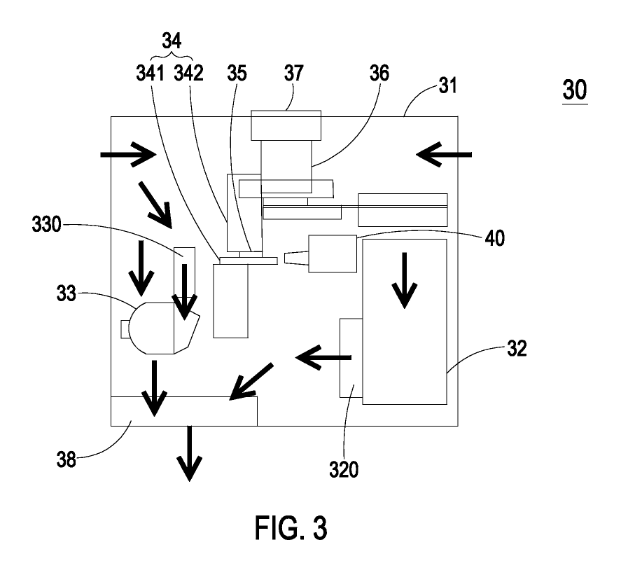

FIG. 3 is a schematic view illustrating the architecture of a projector according to an embodiment of the present invention. In this embodiment, the projector 30 is a digital light processing (DLP) projector. As shown in FIG. 3, the projector 30 at least comprises an outer shell 31, a power source and ignition module 32, a light source module 33, an optical element 34, a sensing element 35, an optical engine 36, a projection lens 37, a systematic fan 38, and a cleaning module 40. The power source and ignition module 32, the light source module 33, the optical element 34, the sensing element 35, the optical engine 36, the projection lens 37, the systematic fan 38 and the cleaning module 40 are all disposed within the outer shell 31.

An example of the optical element 34 includes but is not limited to a color wheel 341, a light guide rod 342 or any other optical element (e.g. a lens or a reflective mirror). The light source module 33 is used for emitting a light beam. The color wheel 341 is used for separating the colors of the light beam. The light guide rod 342 is used for integrating and guiding the light beam. An example of the sensing element 35 includes but is not limited to a sensor of an index board. The sensing element 35 is used for detecting the rotating speed of the color wheel 341. The optical engine 36 mainly comprises a digital micromirror device (DMD) and a lens group.

The operating principles of the DLP projector 30 will be illustrated as follows. Firstly, the light source module 33 emits the light beam. A color separation operation is performed by the color wheel 341. Consequently, the light beam is separated into a green color light, a blue color light and a red color line. The green color light, the blue color light and the red color line are introduced into and homogenized by the light guide rod 342, and then directed to the optical engine 36 (i.e. the DMD). The image input signal is received by the optical engine 36. By finely rotating the micro mirrors of the DMD, the homogenized light and the image generated by the DMD are precisely projected onto the projection lens 37, so that an enlarged image is projected onto a projection screen (not shown).

The projector 30 is further equipped with a heat dissipating mechanism. The heat dissipating mechanism comprises the systematic fan 38 for guiding a cool airflow in the direction indicated by arrows, so that the heat generated by the components within the outer shell 31 can be exhausted to the surroundings. Moreover, the power source and ignition module 32 is optionally equipped with an auxiliary fan 320 for facilitating removing the heat from the power source and ignition module 32. Similarly, the light source module 33 is optionally equipped with another auxiliary fan 330 for facilitating removing the heat from the light source module 33.

However, during the cool airflow is introduced into the projector, external dust is readily introduced into the internal portion of the projector along with the airflow. For protecting the optical element 34 or the sensing element 35 from being contaminated by the dust, the present invention provides a cleaning module for the projector 30.

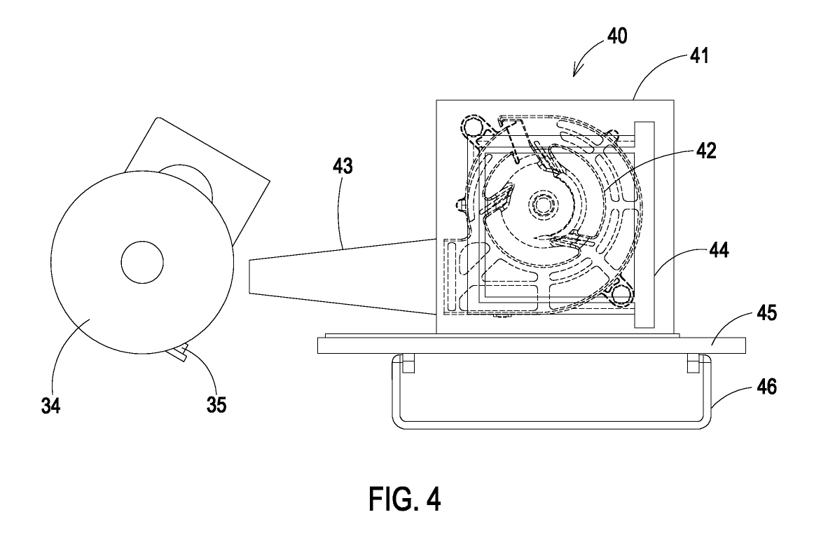

FIG. 4 is a schematic view illustrating a cleaning module and the optical element and the sensing element to be cleaned by the cleaning module according to an embodiment of the present invention. As shown in FIG. 4, the cleaning module 40 comprises a casing 41, an airflow-guiding device 42, and a nozzle 43. The airflow-guiding device 42 is disposed within the casing 41. The nozzle 43 is connected with the casing 41, and in communication with an outlet of the airflow-guiding device 42. An example of the airflow-guiding device 42 includes but is not limited to a fan or a blower. Preferably, the airflow-guiding device 42 is a double-inlet blower. The opening of the nozzle 43 faces the optical element 34 and/or the sensing element 35. Through the nozzle 43, the airflow guided by the airflow-guiding device 42 may be directed to the optical element 34 and/or the sensing element 35. Consequently, the dust on the optical element 34 and/or the sensing element 35 can be removed by the airflow.

In this embodiment, the nozzle 43 is a tapered nozzle. Due to the tapered structure, the speed of airflow ejected from the nozzle 43 is increased, and the airflow can be centralized and directed to the optical element 34 and/or the sensing element 35. Consequently, the performance of the cleaning module is enhanced. As long as the airflow can be guided to the optical element 34 and/or the sensing element 35 by the nozzle 43, the nozzle 43 is not restricted to the tapered nozzle.

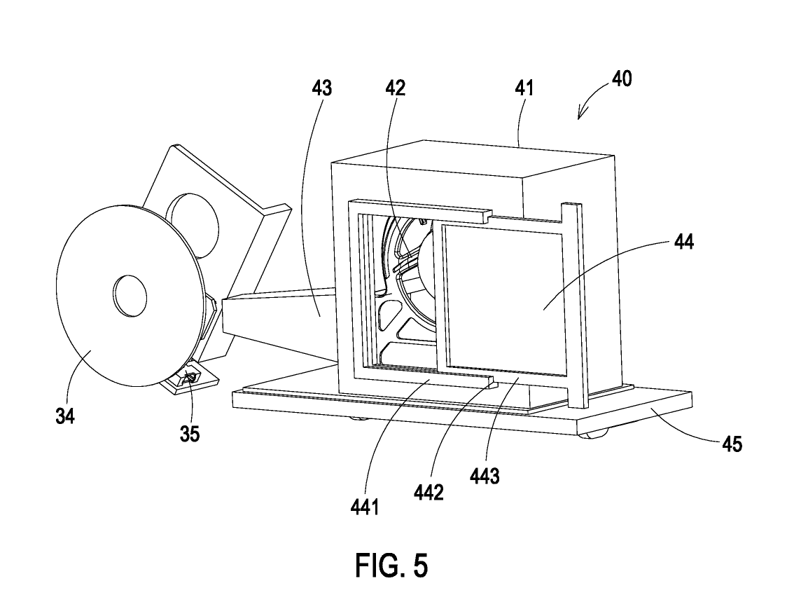

FIG. 5 is a schematic view illustrating the cleaning module, the optical element and the sensing element of FIG. 4 and taken along another viewpoint. As shown in FIG. 5, the cleaning module 40 further comprises an airflow filter 44. The airflow filter 44 is located at an inlet of the airflow-guiding device 42 for filtering the airflow, so that the airflow ejected from the airflow-guiding device 42 is kept clean. Consequently, the airflow ejected from the airflow-guiding device 42 can effectively remove the dust from the optical element 34 and/or the sensing element 35. In accordance with a feature of the present invention, the airflow filter 44 is installed on the cleaning module 40, and it is not necessary to install the airflow filter on the outer shell 31 of the projector 40. Since resistance of the airflow in upstream of the cleaning module 40 is not increased by the airflow filter, the heat-dissipating efficacy of the overall projector 30 is not impaired.

In a preferred embodiment, the airflow filter 44 is replaceable. As shown in FIG. 5, an edge banding 441 is disposed on the casing 41 at the position corresponding to the airflow filter 44. Moreover, a groove 442 is formed in the edge banding 441. By sliding a frame 443 of the airflow filter 44 into the groove 442, the airflow filter 44 can be easily installed on the cleaning module 40. Moreover, by removing the frame 443 of the airflow filter 44 from the groove 442, the airflow filter 44 can be easily detached from the cleaning module 40 in order to be cleaned or replaced with a new one.

Alternatively, in some other embodiments, the cleaning module 40 comprises two airflow filters 44. The two airflow filters 44 are located at two opposite sides of the casing 41 and aligned with the two inlets of the airflow-guiding device 42, respectively.

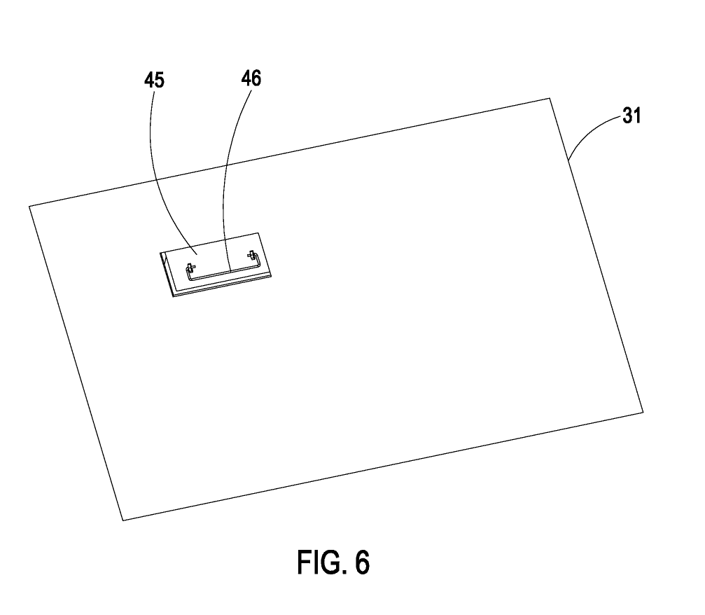

FIG. 6 is a schematic view illustrating a cleaning module installed on a door plate of an outer shell of the projector according to the embodiment of the present invention. Please refer to FIGS. 4, 5 and 6. The casing 41 of the cleaning module 40 is installed on a door plate 45. The door plate 45 has a handle 46. The cleaning module 40 is a removable cleaning module. When the cleaning module 40 is installed on the projector 30, the door plate 45 of the cleaning module 40 is exposed to a side of the outer shell 31 of the projector 30 (see FIG. 6). For repairing the cleaning module 40 or cleaning or replacing the airflow filter 44, the user may grasp the handle 46 in order to pull out the cleaning module 40. Moreover, for reducing the storing space, the handle 46 may be rotated to lie flat on the door plate 45. When the user wants to pull out the cleaning module 40, the handle 46 is rotated to be perpendicular to the door plate 45, so that the cleaning module 40 is pulled out in an effort-saving manner.

From the above discussions, the cleaning module 40 is effective for cleaning the optical element 34 and/or the sensing element 35 of the projector 30. Especially, it is not necessary to seal the optical module or install the airflow filter on the outer shell 31 of the projector 30. Since resistance of the airflow in upstream of the cleaning module 40 is not increased by the airflow filter, the heat-dissipating efficacy of the overall projector 30 is not impaired. In other words, the cleaning module 40 is not responsible for cooling the projector 30. More especially, when the systematic fan 38 is enabled, the airflow-guiding device 42 is disabled. In particular, only when the systematic fan 38 is disabled, the airflow-guiding device 42 is enabled. Consequently, the possibility of adsorbing the dust on the airflow filter 44 of the cleaning module 40 will be minimized.

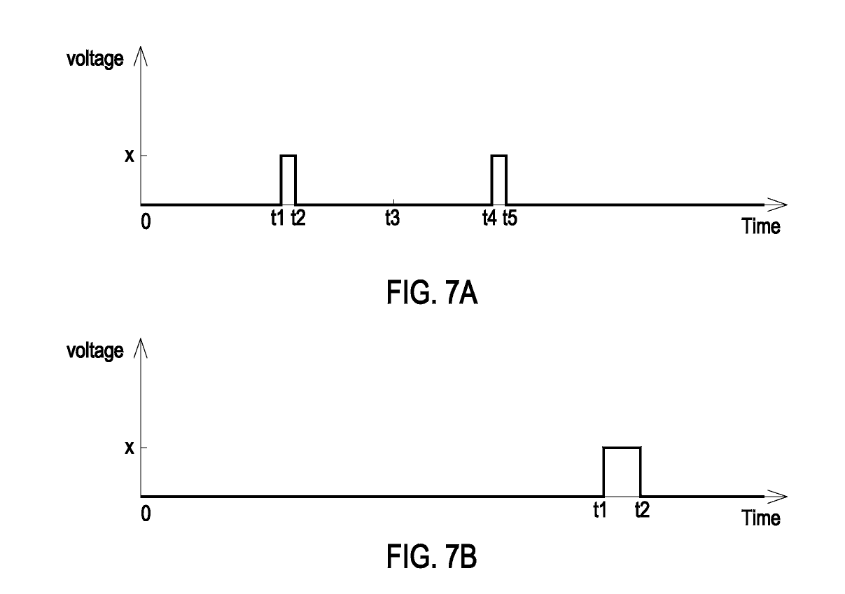

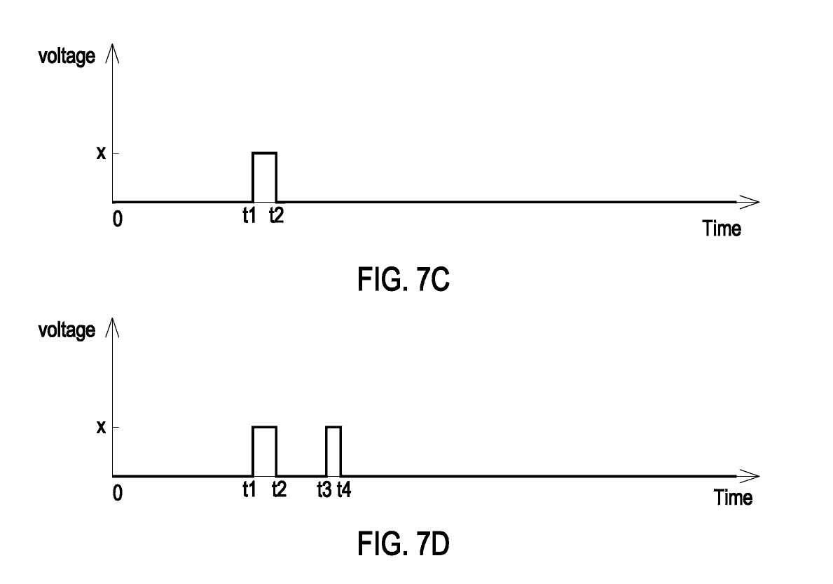

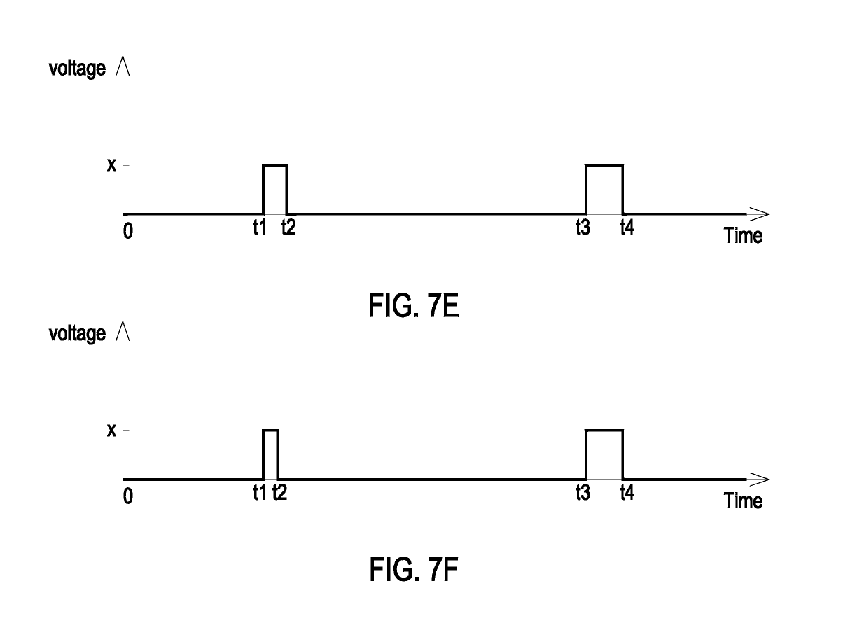

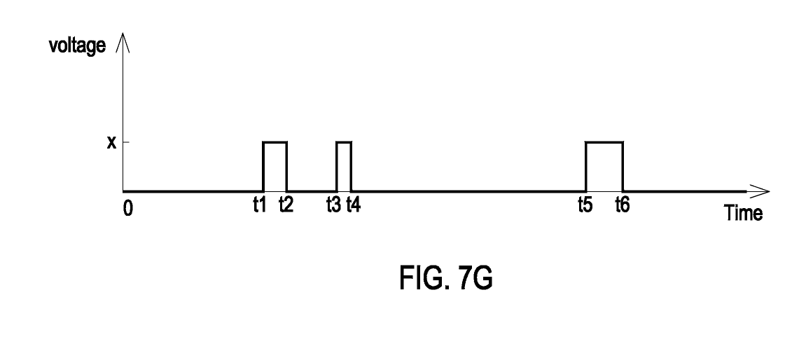

FIGS. 7A˜7G are schematic timing waveform diagrams illustrating the applied voltages of the airflow-guiding device in some possible operating modes of the airflow-guiding device of the cleaning module according to the present invention.

In a first operating mode, whenever the projector is turned off, the airflow-guiding device is automatically enabled to blow off the dust from the optical element or the sensing element at full speed in order to prevent dust accumulation. Please refer to FIG. 7A. Before the time spot t1, the projector is turned on. At the time spot t1, the projector is turned off. Consequently, the airflow-guiding device of the cleaning module is automatically enabled for a specified time period of A seconds, e.g. the time period from t1 to t2. When the airflow-guiding device is enabled, the voltage applied to the airflow-guiding device is at a high-level state (e.g. x voltage). The projector is turned on again at the time spot t3, and turned off at the time spot t4. Consequently, the airflow-guiding device of the cleaning module is automatically enabled for a specified time period of A seconds, e.g. the time period from t4 to t5. As known, if the dust is accumulated on the optical element or the sensing element for a long time, the dust becomes sticky because of moisture and is difficult to be removed. In this operating mode, the airflow-guiding device is automatically enabled to blow off the dust from the optical element or the sensing element whenever the projector is turned off. Consequently, the adsorbed dust before the projector is turned off can be instantly removed, and the possibility of causing dust accumulation will be minimized.

In a second operating mode, if the projector has been used for a preset time period of Y hours (e.g. 100 hours), when the projector is turned off at the latest time, the airflow-guiding device is automatically enabled to blow off the dust from the optical element or the sensing element at full speed in order to prevent dust accumulation. Please refer to FIG. 7B. Before the time spot t1, the projector has been used for many times, and the use time reaches the preset time period of Y hours (e.g. 100 hours). If the above condition is satisfied, when the projector is turned off at the latest time (e.g. at the time spot t1), the airflow-guiding device of the cleaning module is automatically enabled for a specified time period of B seconds, e.g. the time period from t1 to t2.

In a third operating mode, by clicking a cleaning selective item shown on a control panel (not shown) of the projector, the airflow-guiding device may be manually enabled to blow off the dust from the optical element or the sensing element at full speed in order to prevent dust accumulation. Please refer to FIG. 7C. At the time spot t1, the airflow-guiding device is manually enabled. Consequently, the airflow-guiding device of the cleaning module is manually enabled for a specified time period of C seconds, e.g. the time period from t1 to t2.

It is noted that the above three operating modes may be combined with each other to result in other operating modes. Please refer to FIG. 7D. The airflow-guiding device of the cleaning module is manually enabled for a specified time period of C seconds, e.g. the time period from t1 to t2 (i.e. in the third operating mode). The projector is turned on again after the time spot t2, and turned off at the time spot t3. Consequently, the airflow-guiding device of the cleaning module is automatically enabled for a specified time period of A seconds, e.g. the time period from t3 to t4 (i.e. in the first operating mode).

Please refer to FIG. 7E. The airflow-guiding device of the cleaning module is manually enabled for a specified time period of C seconds, e.g. the time period from t1 to t2 (i.e. in the third operating mode). The projector has been used for many times, and the use time reaches the preset time period of Y hours (e.g. 100 hours). When the projector is turned off at the latest time (e.g. at the time spot t3), the airflow-guiding device of the cleaning module is automatically enabled for a specified time period of B seconds, e.g. the time period from t3 to t4 (i.e. in the second operating mode).

Please refer to FIG. 7F. At the time spot t1, the projector is turned off. The airflow-guiding device of the cleaning module is automatically enabled for a specified time period of A seconds, e.g. the time period from t1 to t2 (i.e. in the first operating mode). The projector has been used for many times, and the use time reaches the preset time period of Y hours (e.g. 100 hours). When the projector is turned off at the latest time (e.g. at the time spot t3), the airflow-guiding device of the cleaning module is automatically enabled for a specified time period of B seconds, e.g. the time period from t3 to t4 (i.e. in the second operating mode).

Please refer to FIG. 7G The airflow-guiding device of the cleaning module is manually enabled for a specified time period of C seconds, e.g. the time period from t1 to t2 (i.e. in the third operating mode). At the time spot t3, the projector is turned off. The airflow-guiding device of the cleaning module is automatically enabled for a specified time period of A seconds, e.g. the time period from t3 to t4 (i.e. in the first operating mode). The projector has been used for many times, and the use time reaches the preset time period of Y hours (e.g. 100 hours). When the projector is turned off at the latest time (e.g. at the time spot t5), the airflow-guiding device of the cleaning module is automatically enabled for a specified time period of B seconds, e.g. the time period from t5 to t6 (i.e. in the second operating mode).

The above operating modes of the cleaning module are presented herein for purpose of illustration and description only. It is noted that the operating mode of the cleaning module may be varied according to the practical requirements.

In an implementing example, the airflow-guiding device is a blower and the nozzle is a tapered nozzle. The flow rate of the airflow inhaled by the blower is 0.434 m³/min, the area of the outlet of the blower is 0.00072 m², the average speed of the airflow passing through the blower is 10 m/s, and the area of the outlet of the tapered nozzle is 0.00006 m². Under this circumstance, the average speed of the airflow ejected by the cleaning module is about 120 m/s, so that the dust on the optical element or the sensing element can be effectively blown off.

From the above descriptions, the present invention provides cleaning module for cleaning an optical element or a sensing element of a projector. The cleaning module comprises an airflow-guiding device and a nozzle. An airflow guided by the airflow-guiding device is directed to the optical element or the sensing element to remove dust from the optical element or the sensing element. The cleaning module is not responsible for cooling the projector. In particular, only when the systematic fan is disabled, the airflow-guiding device is enabled. Especially, it is not necessary to seal the optical module or install the airflow filter on the outer shell of the projector. Since resistance of the airflow in upstream of the cleaning module is not increased by the airflow filter, the heat-dissipating efficacy of the overall projector is not impaired. Moreover, since the optical element and the sensing element are not sealed, the heat dissipating efficacy is enhanced. Under this circumstance, the use life of the projector is prolonged without the need of increasing the rotating speed of the systematic fan. Consequently, the noise generated by the systematic fan is reduced. On the other hand, the optical element and the sensing element may be timely cleaned in order to prevent the erroneous action of the projector. Moreover, since the cleaning module is removable and the airflow filter of the cleaning module is replaceable, the cost of maintaining the cleaning module is largely reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A cleaning module for cleaning an optical element or a sensing element of a projector, said cleaning module comprising:
a casing;
an airflow-guiding device disposed within said casing; and
a nozzle connected with said casing and in communication with an outlet of said airflow-guiding device, wherein an opening of said nozzle faces said optical element or said sensing element, so that an airflow guided by said airflow-guiding device is directed to said optical element or said sensing element to remove dust from said optical element or said sensing element,
wherein when a systematic fan of said projector is disabled, said airflow-guiding device is enabled.

2. The cleaning module according to claim 1, wherein said nozzle is a tapered nozzle.

3. The cleaning module according to claim 1, wherein said airflow-guiding device is a fan or a blower.

4. The cleaning module according to claim 1, wherein said airflow-guiding device is a double-inlet blower.

5. The cleaning module according to claim 1, further comprising an airflow filter, wherein said airflow filter is located at an inlet of said airflow-guiding device.

6. The cleaning module according to claim 5, wherein said airflow filter is replaceable.

7. The cleaning module according to claim 1, wherein said cleaning module is a removable cleaning module.

8. The cleaning module according to claim 7, further comprising a door plate, wherein said casing is installed on said door plate, and a handle is disposed on said door plate.

9. The cleaning module according to claim 1, wherein said optical element is a color wheel, a light guide rod, a lens or a reflective mirror.

10. The cleaning module according to claim 1, wherein said sensing element is a sensor of an index board.

11. The cleaning module according to claim 1, wherein after said projector is turned off, said airflow-guiding device is automatically enabled to blow off dust from said optical element or said sensing element.

12. The cleaning module according to claim 1, wherein if said projector has been used for a preset time period, when said projector is turned off at the latest time, said airflow-guiding device is automatically enabled to blow off dust from said optical element or said sensing element.

13. The cleaning module according to claim 1, wherein said airflow-guiding device is manually enabled to blow off dust from said optical element or said sensing element.
